(19) United States
(12) Patent Application Publication
(10) Pub. No.: US 2016/0042361 A1
(43) Pub. Date: Feb. 11, 2016

(54) Apparatuses and methods for the design of a composite building structure where an additional real estate use component shields a visually undesirable real estate use component

(71) Applicant: Brian H. Strout, New York, NY (US)

(72) Inventor: Brian H. Strout, New York, NY (US)

(73) Assignee: TRIZ Advisory IP, Simpsonville, SC (US)

(21) Appl. No.: 14/453,399

(22) Filed: Aug. 6, 2014

(51) Int. Cl. G06Q 30/00; G06Q 50/26; G06Q 50/16

(52) U.S. Cl. CPC G06Q 30/018; G06Q 50/165; G06Q 50/26

(57) ABSTRACT

The subject matter herein describes apparatuses and methods for the design of a composite building structure (170) that includes: (i) a visually undesirable real estate use component (120), which is shielded, partially or wholly, from the public view from offsite of the development site boundary (105); and (ii) an additional real estate use component (130). For some real estate development sites, due to a number of overlapping design constraints, there is a minimal additional real estate use component horizontal distance (135) that would allow for an additional real estate use component (130) horizontally adjacent, either immediately or approximately, to the visually undesirable real estate use component (120). In various embodiments, the additional real estate use component (130), which could fit within these design constraints, can include various restrictions. The combination of the visually undesirable real estate use component (120) and the additional real estate use component (130) generates new apparatuses and methods for the design of a composite building structure (170).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### General

### Parking Garages

For automobile dependent societies, real estate uses need to consider various automobile parking space requirements related to each real estate use. As such, local governments typically dictate the minimum parking space requirements through their zoning codes. For instance, a particular residential use might be required to provide 1.5 spaces per residential unit, or a particular office use might be required to provide a space for every 350 square feet of office space. Rural and suburban areas typically use grade level parking lots to provide areas for parking. However, in dense urban areas it makes more sense to provide parking within a parking garage or “structured” parking due to the higher land values in an urban area. Where the associated land value for providing grade level parking exceeds the associated costs for utilizing structured parking, the parking garage becomes the less expensive alternative.

There are several key terms that describe various types of parking garages. These key terms include: (i) zoning land use classification; (ii) building code ventilation classification; (iii) parking method type classification; and (iv) vertical access classification. Zoning land use classifications include: (i) principal use, where the parking garage is primarily used to provide off-site parking for other properties; and (ii) accessory use, where the parking garage is primarily used to provide on-site parking as an accessory use for the site's principal real estate uses. The accessory use classification can be further describe by having the garage component primarily located: (i) below grade; (ii) above grade and horizontally adjacent to the site's principal uses; and (iii) above grade and stacked vertically below, between, or above the site's principal uses. Next, building code ventilation classifications are: (i) open and (ii) enclosed. The parking method type classifications include: (i) self-park; (ii) attendant; and (iii) automated. Lastly, the vertical access classifications are: (i) ramp access and (ii) elevator access.

Automated parking garages include an entry/exit compartment where the driver parks on a pallet. Once the driver has left the vehicle, he or she uses an electronic key card or coded ticket to activate the storage process. Sensors ensure the vehicle is not too large for the parking system. The vehicle is then moved into the “vault” storage compartment, whereby a motorized transport device slides under the pallet, lifts the pallet, and moves the pallet with the vehicle on top from the entry/exit compartment to the vault compartment. The vault compartment can either be: (i) a multi-level rack system, which both stores and moves the vehicles into place; or (ii) a single-story structure or multi-story structure, which includes an elevator type system, comprised of a level floor, which stores the vehicles and allows the independent motorized transport device to move the vehicles into place.

Additional background is provided by the following excerpt from Parking: Its Effect on the Form and the Experience of the City. The paper written by Stephen Taul, while at Georgia Tech's College of Architecture, discuss the history of parking as it related to various Atlanta properties and Atlanta submarkets.

### Traditional Parking Design

Prior to the introduction of minimum off-street parking requirements in the 1954 Atlanta zoning ordinance, buildings were allowed to be built without on-site parking. This building type can be named “traditional.” Buildings characterized by traditional parking design exhibit an active street frontage with all primary entrances directly off of the public sidewalk. Parking is not supplied onsite and is instead supplied offsite in private or public parking garages or lots. A motorist must therefore park and walk along the public sidewalk to enter the building. With the introduction of the automobile in the early 1900s, all parking was located along the street or in shared garages, so parking did not influence the design of buildings. However, this did not last very long before parking was beginning to be supplied onsite and dedicated to a particular use.

### Modern Parking Design

Once parking began to impact the design and siting of buildings, a building no longer responded only to the sidewalk, but also to its parking. Buildings characterized by modern parking design exhibit an inactive street frontage with secondary entrances off the public sidewalk. Primary entrances are directly connected to parking and most circulation is inside the building. Parking is not necessarily hidden from view of the pedestrian, and can often detract from their experience. A motorist can enter the building without ever having to walk along the public sidewalk. “Modern” parking design can emerge from suburban as well as urban buildings. In general, suburban buildings that exhibit this type of parking design are segregated from the street by surface parking. Urban buildings in this category provide a primary entrance directly from the parking located onsite. Sidewalk entrances are normally secondary in nature and most circulation is internal to the building.

### Contemporary Parking Design

The third type of parking design is “contemporary.” These buildings attempt to both provide a pedestrian-friendly facade as well as off-street parking. Buildings characterized by contemporary parking design, exhibit active street frontage with some primary entrances directly off of the public sidewalk. Parking is supplied onsite, often embedded within the building. When parking is not completely enclosed by the building, its facade is generally masked to make it appear more aesthetically pleasing or disguised as a inhabitable building. A motorist can park and often times enter the building without walking on the public sidewalk. This type of parking is required by zoning in Downtown, Midtown, and Buckhead, and therefore is becoming the norm. This approach to parking has come primarily from the Congress for the New Urbanism, which was founded in 1993. This group of architects sought to codify the principles of creating high-quality urban environments that was in direct contrast to the conventional, sprawl-oriented development practices of the time (Congress for the New Urbanism, 2011). Through form-based codes and the creation of LEED for Neighborhood Development, principles such as hiding parking have been written into law.

Residential buildings in this category can be divided into two groups: low to mid-rise buildings with interior block parking, and high-rise buildings with embedded parking. Post Biltmore apartment building is an example of a mid-rise building. It contains double-loaded corridors with interior units facing a courtyard and a single-loaded corridor when attached to the parking deck in the interior of the block. It is possible for residents and visitors alike to enter the building from the parking garage without ever having to walk along the sidewalk. It contains several pedestrian entrances from the sidewalk and maintains a street wall with glazing for the leasing office and common rooms on the ground floor. Therefore, it attempts to address the street as a traditional building, but hides a separate circulation system for motorists. It is the best example of the building type known as “Texas Donut.” High-rise residential buildings, such as Spire, contain ground-floor retail with several levels of parking above the ground floor and residential levels above the parking garage. In the same way the mid-rise residential example attempts to maintain an active street presence, it also hides a separate circulation system for motorists. But unlike mid-rise buildings, high-rise residential buildings often reveal their parking garages above the ground floor. The parking deck greatly impacts the design of the building. It is obvious to pedestrians that the building form is completely determined by the amount of parking supplied, . . .

### Parking Garage—Aesthetic Issues

The construction of a parking garage can generate aesthetic issues. In urban areas where a vertical wall or face of the parking garage is going to face the general public or a neighboring property, the traditional or modern parking garage design can be viewed by some community individuals as unattractive. This unattractiveness can generate unhappy adjacent landowners and feel out of place from a community planning perspective. For situations where a developer is trying to develop a real estate project and the developer is seeking a land use rezoning approval from the local government, community individuals can express their unhappiness with the project at the rezoning's public hearings. If there is sufficient public outcry over the project's rezoning, this can prevent the rezoning from being approved or can force the developer to make substantial design concessions to ultimately get the project's rezoning approved. The first scenario means the developer won't recoup the indirect opportunity costs and the direct sunk costs. The indirect opportunity costs arise from time and energy that could have been spent on other development opportunities the developer could have pursued, and the direct sunk costs arise from preparing third party professional reports that can go into a rezoning. The second scenario means the developer will have to spend additional time and money to redesign the project to get it over the opposition threshold where the rezoning would be approved by the local government.

There are several existing approaches that can be used to dress up a traditional or modern parking garage to make its appearance more desirable. These approaches include the use of: (i) green screens; (ii) fake facades; or (iii) the “Texas Donut.” Green screens incorporate plant materials either directly to the parking garage structure or to external lattices. Fake facades use architectural features to break up an entire parking garage facade into smaller visual segments. These segments, which look like smaller individual buildings, allow the parking garage to blend in better with the surrounding streetscape. The Texas Donut is a design where the developer tries to place most, if not all of the parking garage component behind a residential use component associated with the project. The Texas Donut uses the residential use component to provide a more attractive facade, as viewed from offsite of the project, versus seeing the parking garage component.

### Parking Garage—Site & Design Limitations

Aesthetic considerations might require a project go above and beyond the design options of green screens or fake facades. However, the size and shape of the development site along with the preferred size considerations of the parking garage layout, may not allow for the use of the Texas Donut. The spacing between the exterior walls or faces of the parking garage and the development site boundaries, or the development site zoning setbacks, might be too narrow and would not allow for a typical residential unit to be placed in the remaining area. Parking lot isles or “bays”, either double or single loading, have certain functional dimensional constraints. For instance, a parking or bay of double 90 degree angled parking needs a module approximately 62′ wide. As such, a development development with a depth of 144′ that needs to use to two parking modules at 62′ would mean the development site would only have 20′ remaining for other possible real estate uses. Either 20′ on one side of the parking garage use component, or 10′ on opposing sides of the parking garage.

### Scale & Layout Considerations

Scale in real estate development projects has significant meaning versus other non-inhabitable objects because people utilize the spaces provided by various real estate uses. For example, a clock can be 2″ in height or 20′ in height, and it can still perform its function. Conversely, if one were to take a bedroom and reduce it from 15′×15′×12′ to 3′×3′×2′, the bedroom could not perform its function as a bedroom. Likewise, real estate uses such as, but not limited to: (i) residential; (ii) retail; (iii) office; (iv) hospitality; (v) parking; and (vi) public space all have various levels of scale that make them functional. Besides just the length, depth, and height of a building, the combination of the length and depth also generates a “floor plate”. Where the shape and dimensions of the floor plate can also generate a space that is more or less functional depending on the individual type of real estate use.

Besides just the depth dimension and gross floor plate considerations, there are layout inefficiencies to consider. These layout inefficiencies can include considering the incorporation of: (i) hallways; (ii) stairs; (iii) elevators; (iv) escalators; (v) the placement of doors; and (vi) the placement of windows, (collectively “access considerations”). Layout inefficiencies can also include considering the placement of: (i) bathrooms; (ii) mechanical system areas; and (iii) storage areas, (collectively “building support considerations”). Then there are the local building regulations that dictate the dimensions and locations of these access considerations and building support considerations for fire and safety reasons. As such, the combination all of these considerations lead to a suboptimal design and layout of the overall project and underutilization of the development site since the use of the Texas Donut may require a reduction of the horizontal dimensions of the parking garage layout to allow for the practical implementation of the Texas Donut design. If an individual adds up all of these overlaying considerations for designing a building, certain configurations are suboptimal and others are not viable.

How scale and layout can be important considerations for a particular real estate use is illustrated by the following excerpt from Floorplate Shapes and Office Layouts: A Model of the Effect of Floorplate Shape on Circulation Integration. The core referenced therein is the building core, which contains the elevator shafts and the main emergency stairwells.
. . . all speculative offices designed by the Atlanta-based Firm Cooper Carry Architects during the period 1999-2001 conform to a basic type of a rectangular 245×115 ft plan, a 100×20 central core, and a 40 ft deep tenant space (FIG. 2.1). This type is widely spread particularly in American suburban office parks where development site constraints are non-existent.
The grammar of description of office shells is based on three elements: the location of the core in relation to the shell; the position of major circulation routes; and the depth of office space. Different locations of the core in relation to the shell, internal, semi-internal, and external result in spaces with different depths from the core to perimeter. Thus, shells are characterized by the depths of the spaces they provide: very deep, deep, medium and shallow (FIG. 2.5). Very deep space is described as being over 20 m deep, deep space as being 11-19 m deep, medium as 6-10 m, and shallow space as being 4-5 m deep. For example, a long and narrow building can only be subdivided into shallow spaces, while a rectangular building with a central core can provide both shallow and medium depth spaces. The position of cores also determines the starting point of major circulation systems. Corridors are classified: first, according to whether they serve spaces in one or both sides; and second, according to their configuration: linear connecting two separate cores, O-shape or Z-shape surrounding central cores. For very deep spaces, circulation systems are free from constraints of core or shell, thus allowing several configurations.

### Other Visually Undesirable Real Estate Uses—Aesthetic Issues

The same aesthetic issues that were described concerning parking garages can also be applicable to other types of visually undesirable real estate uses. Therefore, these visually undesirable real estate uses also represent the same opportunity as a parking garage for generating new composite building structures that provide unique alternative solutions for shielding visually undesirable real estate uses from public view.

A boat dry stack storage building is where boats are stored in a covered area within a vertical rack system versus being kept in the water at a boat dock or at an individual boat slip. The boats are transported between the covered area and the water for use by a counterbalanced forklift or an overhead crane. The buildings providing this type of use are generally industrial or warehouse looking in nature due to those building's typical construction materials.

A boat dry stack storage building, along with other visually undesirable real estate uses, such as: (i) a self-storage building; (ii) a garbage facility; (iii) a recycling facility; (iv) a power generation facility; or (v) a data center facility, provide similar scenarios to the parking garage scenario previously mentioned. These other visually undesirable real estate uses are housed in less than attractive buildings.

### Solar Chimney

Solar chimney, also often referred to as a thermal chimney, is a vertical shaft that provides for the natural ventilation of buildings. It uses the convection of air heated by passive solar energy. The updraft of the heated air in the chimney creates suction at the inlet of the chimney that can be used to ventilate a building.

### BACKGROUND

### Prior Art

Understanding the current prior art for parking garages is partially based on understanding the building codes that governor the construction of various types of parking garages.

### Building Codes

By July 2008, all 50 states and the District of Columbia had adopted the International Code Council's (ICC) established 2000, 2003, or 2006 International Building Code (IBC). The following paragraphs are provided in Chapter 18 and 19 of The Dimensions of Parking book.

### Open Parking Structures

Open parking structures are those that have sufficient openings around the exterior to provide for natural ventilation. The international codes do not require mechanical ventilation or sprinkler systems for open parking structures. However, some jurisdictions may add special amendments that alter the international code, such as requiring fire-sprinklers in open parking garages, IBC 2006 establishes the following criteria for open parking structures:
For natural ventilation purposes, the exterior sides of the structure shall have uniformly distributed openings on two or more sides. The area of such openings in exterior walls on a tier must be at least 20 percent of the total perimeter wall area of each tier. The aggregate length of the openings considered to be providing natural ventilation shall constitute a minimum of 40 percent of the perimeter of the tier. Interior walls shall be at least 20 percent open with uniformly distributed openings.
Exception: Openings are not required to be distributed over 40 percent of the building perimeter where the required openings are uniformly distributed over two opposing sides of the building.

Light wells are sometimes used to provide natural ventilation and light for tiers that are partially or entirely below grade. There are no code requirements for the width or light wells; however, if the aggregate width of the wells around the perimeter is equal to the aggregate height of the vertical openings required for the below-grade levels, many jurisdictions allow basement levels to be classified as open parking structures.

### Enclosed Parking Structures

Parking structures that do not meet the criteria for open parking garages are classified as enclosed (“open parking garages” and “enclosed parking garages” are the technical terms used in the IBC), which means they require mechanical ventilation, sprinklers, and enclosed stairwells. Lower portions of parking structures that are partially or entirely below grade may be classified as enclosed, while the upper portions may be classified as open.

In enclosed parking structures with less than four stories, enclosed stairwells with a one-hour fire rating are required; in enclosed structures with four stories or more, enclosed stairwells with a two-hour fire rating are required. At least one accessible means of egress is required in all parking facilities. For parking structures with four or more stories above or below the level of exit discharge, at least one of the required accessible means of egress must be an elevator; buildings with three stories or less are not required to have an elevator. Enclosed parking structures must provide an area of refuge at an accessible staircase for wheelchair patrons. This area must be separated from the rest of the structure by a smoke barrier. Accessible stairwells must have a clear width of 48 inches (122 centimeters) between handrails.

### Building Separation

Parking structures within 5 feet (1.5 meters) of a common property line must have an enclosed fire wall between the exterior or the structure and the property line, and the wall must (1) have at least a one-hour fire-resistance rating and (2) no openings. A fire wall is not required if the garage is ten feet or more from the property line.

Contrary to previous codes, the IBC allows a mix of uses in open parking garages, as long as they meet the fire-separation provisions. Generally, such provisions require a two-hour horizontal and vertical fire separation between the parking garage and other uses.

### Mechanical Ventilation

As mentioned earlier, parking garages that do not meet the criteria for open parking structures require mechanical ventilation. The ICC's International Mechanical Code specifics the requirements for such ventilation systems. A system's ventilation fans are allowed to operate intermittently if carbon monoxide monitoring is provided and if the system automatically turns on in response to the presence of vehicle operation or people in the garage. The mechanical code also calls for a minimum ventilation rate when an automated system is being used. In addition, if the garage has connecting offices, waiting rooms, ticket booths, or other similar uses, these spaces must be maintained under positive pressure (i.e. the air pressure inside the occupied space must be higher than it is outside the space).

### Fire Protection

Parking structures must be constructed of noncombustible material. Open parking structures that are less than 150 feet (46 meters) above the lowest level of fire department access must have a Class 1 manual standpipe system with a ground level fire department connection or attaching a water supply. Standpipes are not required where the highest story is located 30 feet (9 meters) or less above the lowest level of fire department access. Class I manual dry standpipes are allowed in open parking garages subject to freezing, provided that they are located so that all portions of the building are within 30 feet of a nozzle attached to 100 feet (30 meters) of hose. Where more than one standpipe riser is provided, standpipes must be interconnected.
Under the ICC's International Fire Code, 4A:80BC-rated, dry-chemical fire extinguishers are required for parking structures, which are classified as ordinary hazards. Fire extinguishers must be located no more than 75 feet (23 meters) from any location on a floor, and the maximum floor area per extinguisher is 11,250 square feet (1,045 square meters).
Enclosed parking structures must have fire alarms and (1) automatic sprinkler systems activated by heat, or (2) smoke detectors placed throughout the structure.

Given all of the various more stringent ICC code differences, for an enclosed parking garage versus open parking garage, an individual can see the tendency to utilize open parking structures to minimize the additional costs associated with the more stringent building codes when the size and shape of the development site allow it. A self-park, ramp-accessed garage generally requires a minimum land area of approximately 150 feet by 125 feet (46 by 38 meters).

### Texas Donut

While the prior art includes the Texas Donut concept, there are a few important distinctions to make regarding the Texas Donut. First, the Texas Donut uses a specific additional real estate use component, a residential use, to shield a specific visually undesirable real estate use component, an accessory parking garage use. Second, for the Texas Donut, the additional real estate use component, the residential use, drives the primary need for the visually undesirable real estate use component, the accessory parking garage use.

### SUMMARY

The subject matter herein describes apparatuses and methods for the design of a composite building structure. The composite building structure includes a visually undesirable real estate use component, which is to be shielded, partially or wholly, from the public view from offsite of the development site, and an additional real estate use component. For some real estate development sites, there is a minimal horizontal distance, due to a number of overlapping design constraints, that would allow for an additional real estate use component horizontally adjacent, either immediately or approximately, to the visually undesirable real estate use component. In various embodiments, the additional real estate use component, which could fit within these design constraints, can include restrictions on: (i) the type of use for a visually undesirable real estate use component; (ii) the type of use for an additional real estate use component; (iii) the layout of a common access area or a plurality of common access areas for the floors above the ground floor; and (iv) the additional real estate use component's utilization of a common vertical wall between said additional real estate use component and said visually undesirable real estate use component. As such, the combination of the visually undesirable real estate use component and the additional real estate use component generates new apparatuses and methods for the design of a composite building structure.

### ADVANTAGES

Accordingly several advantages of one or more aspects are as follows. As previously mentioned, the scale and layout considerations related to various additional real estate use components provide an opportunity of generating new composite building structures. The narrower horizontal distance, which would otherwise be deemed not practical for an additional real estate use component, of some development sites represents an opportunity of generating new apparatuses and methods for the design of a composite building structure.

Numerous embodiments relate to an additional real estate use component that comprises a parking garage use, which would be classified as an enclosed parking garage versus an open parking garage. The inclusion of a solar chimney provides benefits for these embodiments. One benefit is the ability to save on energy costs versus running a mechanical ventilation system to generate 100% of the required ventilation outlined by the ICC code. Alternatively, for automated enclosed parking structures, where the vehicles are not running and generating exhaust while in the parking vault area, the ventilation provided by a solar chimney can provide 100% of the ventilation required by the ICC code. As such, the inclusion of a solar chimney could provide the ventilation necessary to meet these code requirements, whereby the composite building structure would not need to spend the capital expense for a mechanical ventilation system to generate the required ventilation. For embodiments where a mechanical ventilation system is still required, the use of a solar chimney would reduce the operational expense by downsizing the required mechanical ventilation system. As such, the inclusion of a solar chimney represents an opportunity of generating new apparatuses and methods for the design of a composite building structure.

The utilization of various types of uses for a visually undesirable real estate use component represents an opportunity of generating new apparatuses and methods for the design of a composite building structure. The utilization of other visually undesirable real estate uses besides parking garage uses, such as: (i) a boat dry stack storage building; (ii) a self-storage building; (iii) a garbage facility; (iv) a recycling facility; (v) a power generation facility; or (vi) a data center facility, as a visually undesirable real estate use component, represents an opportunity of generating new apparatuses and methods for the design of a composite building structure. The utilization of commercial uses such as: (i) a restaurant use; (ii) an alcohol drinking establishment use; (iii) a museum use; or (iv) an art gallery use, which have unique utilizations of a common vertical wall between said additional real estate use component and said visually undesirable real estate use component, as a visually undesirable real estate use component represents an opportunity of generating new apparatuses and methods for the design of a composite building structure.

The utilization of residential uses such as: (i) townhouses; (ii) apartments, which have unique access considerations; or (iii) residential condominiums, which have unique access considerations, as the additional real estate use component represents an opportunity of generating new apparatuses and methods for the design of a composite building structure.

These various advantages generate the following benefits: (i) shield the visually undesirable real estate use component; (ii) allow the development site to be more fully utilized, which reduces the buildable per square foot cost for a given development site acquisition price; (iii) generate additional revenue from the additional real estate use component; (iv) provide alternative combinations of access for when an additional real estate use component is subdivided; (v) allow a composite building structure to secure a local governmental rezoning approval, which the development site would not otherwise receive; or (vi) allow a composite building structure to secure a governmental subsidy, which other building structures would not otherwise receive. Other advantages of one or more aspects will be apparent from a consideration of the drawings and ensuing description.

### DRAWINGS—FIGURES

A more complete understanding of the present invention may be derived by referring to the detailed description and claims when considered in connection with the Figures.

FIG. 1—shows a vertical cross section depicting a composite building structure with two additional real estate use components on opposing sides of a visually undesirable real estate use component in accordance with one embodiment.

FIG. 2—shows a vertical cross section depicting an alternative composite building structure with an additional real estate use component on one side of a visually undesirable real estate use component in accordance with another embodiment.

FIG. 3—shows a horizontal cross section, which applies to building floors above the ground floor, depicting a composite building structure: (i) wherein an additional real estate use component is subdivided into a plurality of horizontal units; and (ii) the common access areas, in accordance with another embodiment.

FIG. 4—shows an alternative horizontal cross section, which applies to building floors above the ground floor, depicting an alternative composite building structure: (i) wherein an additional real estate use component is subdivided into a plurality of horizontal units; and (ii) a common access area, in accordance with another embodiment.

FIG. 5—shows an alternative horizontal cross section, which applies to building floors above the ground floor, depicting an alternative composite building structure: (i) wherein an additional real estate use component is subdivided into a plurality of horizontal units; and (ii) a common access area, in accordance with another embodiment.

FIG. 6—shows an alternative horizontal cross section, which applies to building floors above the ground floor, depicting an alternative composite building structure: (i) wherein an additional real estate use component is subdivided into a plurality of horizontal units; and (ii) a common access area, in accordance with another embodiment.

FIG. 7—shows an alternative horizontal cross section depicting an alternative composite building structure: (i) wherein an additional real estate use component is a residential use subdivided into a plurality of townhouse units; and (ii) the direct ground level entrances for the plurality of townhouse units, in accordance with another embodiment.

FIG. 8—shows a method flowchart for the design of a composite building structure.

### DRAWINGS—REFERENCE NUMBERS

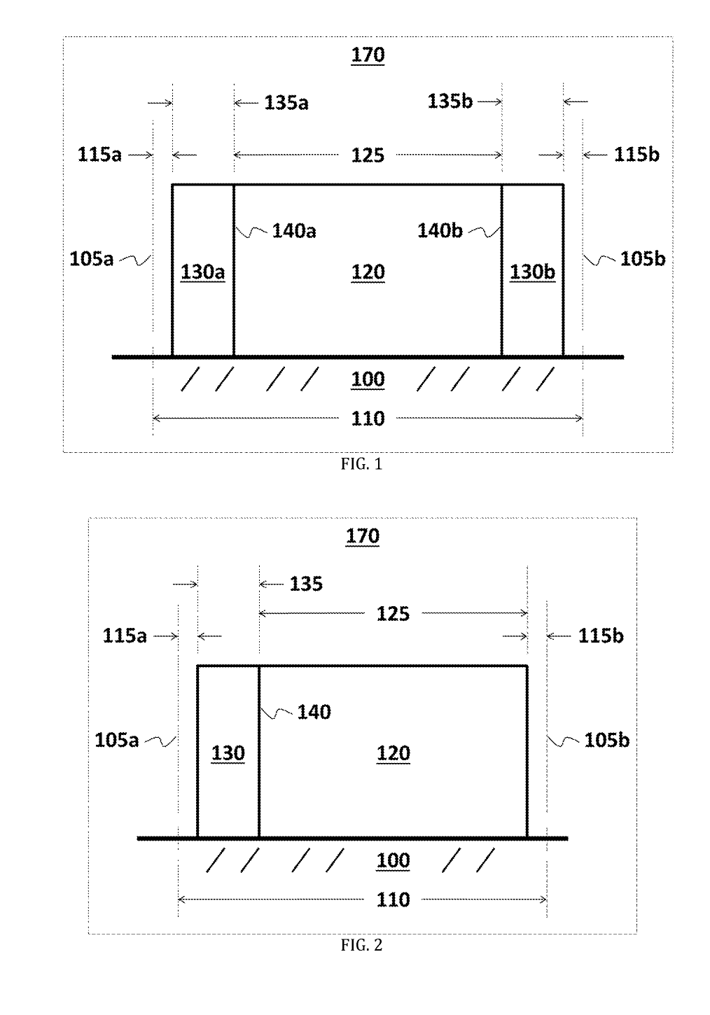

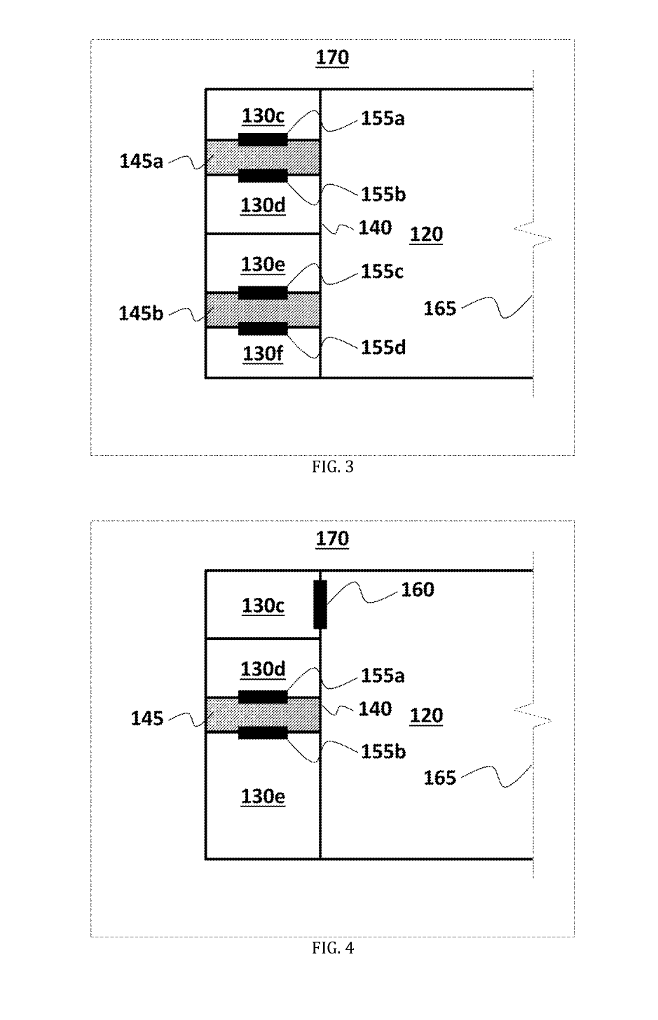

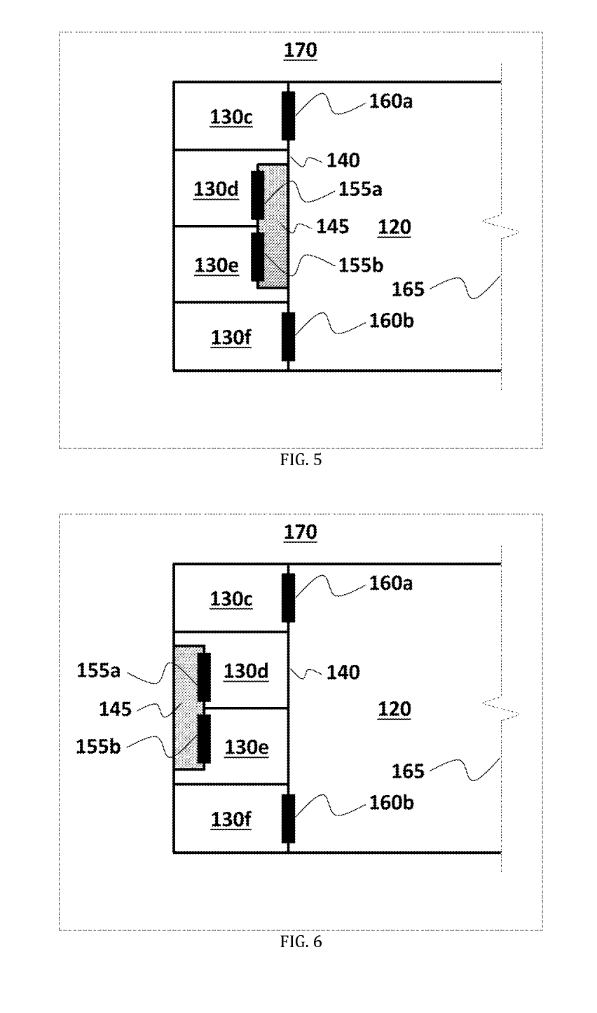

In the individual Figures, the same type of item, which may or may not have the same distances or orientations, utilize the same reference number but with different alphabetic suffixes. The same reference number, along with any alphabetic suffix, does not refer to the same instance of any individual item among different Figures. The lead lines point to objects, and the lead lines with arrowheads represent the distance between two items. While the ground in the Figures is depicted as level, the ground for a composite building structure may or may not be level. While not expressly depicted in the Figures, a common access area for any one floor, as depicted in the horizontal sections, would be connected to any floors above of below that floor. A connection could include, but is not limited to: (i) a staircase; (ii) an elevator; (iii) an escalator; or (iv) a ramp. The Figures are not drawn to scale. The vertical cross sections FIGS. 1-2 and the horizontal cross sections FIGS. 3-7 are to be considered together as an example of any one embodiment.

Apparatus Elements

100. Ground

105. Development Site Boundary

110. Development Site Boundary Horizontal Distance

115. Development Site Zoning Restrictions

120. Visually Undesirable Real Estate Use Component

125. Visually Undesirable Real Estate Use Component Horizontal Distance

130. Additional Real Estate Use Component

135. Additional Real Estate Use Component Horizontal Distance

140. Common Vertical Wall

145. Common Access Area

150. Direct Ground Floor Entrance

155. Common Access Area Entrance

160. Visually Undesirable Real Estate Use Component Entrance

165. Figure Section Break

170. Composite Building Structure

Method Elements
200. Determining the minimum volumetric configuration, based on a singular or a plurality of length, width, and height configurations, of a visually undesirable real estate use component
205. Determining, either based on the current zoning or on an anticipated rezoning request for said development site, any anticipated real estate uses for an additional real estate use component
210. Determining the interactions between: (i) said visually undesirable real estate use component; (ii) said additional real estate use component; (iii) a plurality of current development site zoning restrictions; (iv) a plurality of applicable future development site zoning restrictions after an anticipated rezoning request or variance; and (v) the local government's building code restrictions related to a plurality of possible composite building structures
215. Selecting a viable composite building structure from said plurality of possible composite building structures
220. Comparing a selected said viable composite building structure with the designs of other alternative buildings
225. Choosing said selected viable composite building structure if it provides more value than the designs of other alternative buildings

### DESCRIPTION—FIG. 1—APPARATUS, VERTICAL CROSS SECTION

The vertical cross section of FIG. 1 depicts a composite building structure (170) where the development site has is a minimal horizontal distance, due to a number of overlapping design constraints. The overlapping design constraints comprise: (i) the development site boundaries (105a and 105b); (ii) a site boundary horizontal distance (110); (iii) the development site zoning restrictions (115a and 115b), which in FIG. 1 are setback restrictions; (iv) a visually undesirable real estate use component horizontal distance (125); and (v) the additional real estate use component horizontal distances (135a and 135b). The ground (100) and the common vertical walls (140a and 140b) are provided for reference due to their general relationship to the composite building structure (170). The composite building structure (170) is comprised of a visually undesirable real estate use component (120) and the additional real estate use components (130a and 130b) on opposite sides of the visually undesirable real estate use component (120).

FIG. 1 illustrates a first class of apparatus embodiments for the composite building structure (170). The visually undesirable real estate use component (120) and the additional real estate use components (130a and 130b) do not have any restrictions on the types of real estate uses that constitute either component. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

FIG. 1 also illustrates a second class of apparatus embodiments for the composite building structure (170). If both of the additional real estate use components (130a and 130b) are commercial uses, then the visually undesirable real estate use component (120) could be any type of visually undesirable real estate use. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

FIG. 1 also illustrates a third class of apparatus embodiments for the composite building structure (170). If either one of the additional real estate use components (130a or 130b) is a residential use, where the visually undesirable real estate use component (120) is accessory to the residential use, then the visually undesirable real estate use component (120) could be any type of visually undesirable real estate use except an accessory use parking garage. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; or (vii) a principal use parking garage. Alternatively, the composite building structure (170) described immediately above included other constraining limitations, as provided for by an applicable dependent claim, the visually undesirable real estate use component (120) could also be an accessory use parking garage.

FIG. 1 also illustrates a fourth class of apparatus embodiments for the composite building structure (170). The composite building structure (170) could be an embodiment where: (i) either one of the additional real estate use components (130a or 130b) is a residential use, where the visually undesirable real estate use component (120) is not accessory to the residential use; and (ii) the residential use has some restrictions, as provided for by an applicable dependent claim, to the layout of any common access area for floors above the ground floor. Some possible embodiments are shown in the horizontal cross sections in FIGS. 3-6. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

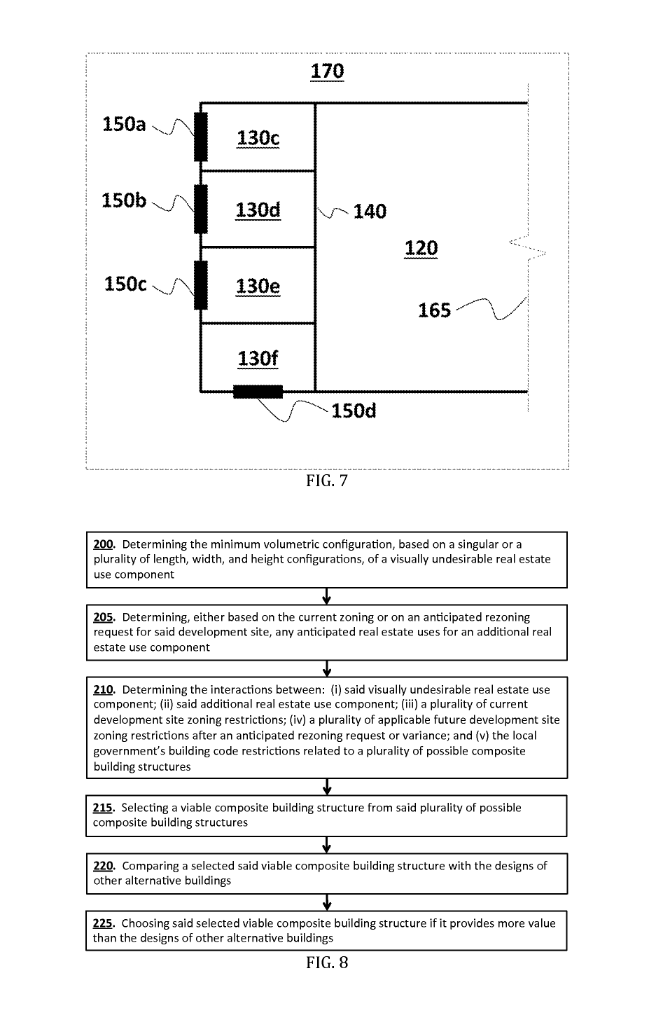

FIG. 1 also illustrates a fifth class of apparatus embodiments for the composite building structure (170). The composite building structure (170) could comprise: (i) either one of the additional real estate use components (130a or 130b) that is a residential use; and (ii) the residential use being a plurality of townhouse units. The visually undesirable real estate use component (120) could be any type of visually undesirable real estate use. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage. A possible embodiment is shown in the horizontal cross section in FIG. 7.

### DESCRIPTION—FIG. 2—APPARATUS, ALTERNATIVE VERTICAL CROSS SECTION

The vertical cross section of FIG. 2 depicts a composite building structure (170) where the development site has is a minimal horizontal distance, due to a number of overlapping design constraints. The overlapping design constraints comprise: (i) the development site boundaries (105a and 105b); (ii) a site boundary horizontal distance (110); (iii) the development site zoning restrictions (115a and 115b), which in FIG. 2 are setback restrictions; (iv) a visually undesirable real estate use component horizontal distance (125); and (v) an additional real estate use component horizontal distance (135). The ground (100) and the common vertical wall (140) are provided for reference due to their general relationship to the composite building structure (170). The composite building structure (170) is comprised of a visually undesirable real estate use component (120) and an additional real estate use component (130) on one side of the visually undesirable real estate use component (120).

FIG. 2 illustrates a sixth class of apparatus embodiments for the composite building structure (170). The visually undesirable real estate use component (120) and an additional real estate use component (130) do not have any restrictions on the types of real estate uses that constitute either component. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

FIG. 2 also illustrates a seventh class of apparatus embodiments for the composite building structure (170). If the additional real estate use component (130) is a commercial use, then the visually undesirable real estate use component (120) could be any type of visually undesirable real estate use. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

FIG. 2 also illustrates an eighth class of apparatus embodiments for the composite building structure (170). If the additional real estate use component (130) is a residential use, where the visually undesirable real estate use component (120) is accessory to the residential use, then the visually undesirable real estate use component (120) could be any type of visually undesirable real estate use except an accessory use parking garage. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; or (vii) a principal use parking garage. Alternatively, the composite building structure (170) described immediately above included other constraining limitations, as provided for by an applicable dependent claim, the visually undesirable real estate use component (120) could also be an accessory use parking garage.

FIG. 2 also illustrates a ninth class of apparatus embodiments for the composite building structure (170). The composite building structure (170) could be an embodiment where: (i) the additional real estate use component (130) is a residential use, where the visually undesirable real estate use component (120) is not accessory to the residential use; and (ii) the residential use has some restrictions, as provided for by an applicable dependent claim, to the layout of any common access area for floors above the ground floor. Some possible embodiments are shown in the horizontal cross sections in FIGS. 3-6. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage.

FIG. 2 also illustrates a tenth class of apparatus embodiments for the composite building structure (170). The composite building structure (170) could comprise: (i) a additional real estate use component (130) that is a residential use; and (ii) the residential use being a plurality of townhouse units. The visually undesirable real estate use component (120) could be any type of visually undesirable real estate use. As such, the visually undesirable real estate use component (120) could include, but is not limited to, the following uses: (i) a boat dry stack storage building; (ii) a self storage building; (iii) a garbage facility; (iv) recycling facility; (v) a power generation facility; (vi) a data center facility; (vii) a principal use parking garage; or (viii) an accessory use parking garage. A possible embodiment is shown in the horizontal cross section in FIG. 7.

### DESCRIPTION—FIGS. 3-6—APPARATUS, HORIZONTAL CROSS SECTIONS

Alternative views of the various classes of embodiments provided in FIGS. 1 and 2 are illustrated by FIGS. 3-6. These views are horizontal cross sections depicting floors above the ground floor of a composite building structure (170). The composite building structure (170) is comprised of an additional real estate use component that is subdivided into a plurality of additional real estate use components (130c, 130d, 130e, and 130f).

Further, FIGS. 3-6 illustrate various classes of embodiments with either a common access area (145) or a plurality of common access areas (145a and 145b). The plurality of additional real estate use components (130c, 130d, 130e, and 130f) have ingress and egress by one of two means. First, the ingress and egress maybe provided by the plurality of common access area entrances (155a, 155b, 155c, and/or 155d). Second, the ingress and egress maybe provided by the plurality of visually undesirable real estate use component entrances (160, 160a and/or 160b) located along the common vertical wall (140). The figure section break (165) is referenced since FIGS. 3-6 focus on one side of the visually undesirable real estate use component (120).

### DESCRIPTION—FIG. 7—APPARATUS, ALTERNATIVE HORIZONTAL CROSS SECTION

An alternative view of the various classes of embodiments provided in FIGS. 1 and 2 is illustrated by FIG. 7. This view is a horizontal cross section depicting the ground floor of a composite building structure (170). The composite building structure (170) is comprised of an additional real estate use component that is a residential use subdivided into a plurality of townhouse units (130c, 130d, 130e, and 130f).

Further, FIG. 7 illustrates one class of embodiments with of a plurality of direct ground floor entrances (150a, 150b, 150c, and 150d) that provide direct ingress and egress to the exterior of the composite building structure (170). The common vertical wall (140) and the figure section break (165) are referenced since FIG. 7 focuses on one side of the visually undesirable real estate use component (120).

### DESCRIPTION—FIG. 8—METHOD, FLOWCHART

One embodiment of a method for the design of a composite building structure (170) is illustrated by FIG. 8. The method flowchart describes the design process for a composite building structure (170) comprising: (i) an additional real estate use component (130); and (ii) a visually undesirable real estate use component (120) that is shielded, partially or wholly, from the public view from offsite of the development site by said additional real estate use component (130).

### Conclusion, Ramifications, & Scope

Accordingly, the reader will see the subject matter herein describes apparatuses and methods for the design of at least one embodiment of a composite building structure. The composite building structure includes a visually undesirable real estate use component, which is shielded, partially or wholly, from the public view from offsite of the development site, and an additional real estate use component.

At least one embodiment of the composite building structure generates additional revenue for a development site. The additional revenue is generated from the rent from the usable square footage provided by the additional real estate use component. This benefit can allow this embodiment of the composite building structure to a more financially feasible building versus other alternative building designs for the development site.

At least one embodiment of the composite building structure can allow a developer to more fully utilize the allowable buildable area of a development site. This reduces the buildable per square foot land cost for the project at a given negotiated price for the development site.

At least one embodiment of the composite building structure allows the composite building structure to secure a local governmental rezoning approval that other alternative building designs for the development site would not otherwise receive. At least one embodiment of the composite building structure allows the composite building structure to secure a governmental subsidy that other alternative building designs for the development site would not otherwise receive. Either one of these benefits can allow that embodiment of the composite building structure to become a more financially feasible building versus other alternative building designs.

While the above description contains many specifications, these should not be construed as limitations on the scope of any embodiment, but as exemplifications of various embodiments thereof. For example, the walls or faces of either the visually undesirable real estate use component or the additional real estate use component may not be parallel. Also, either of those walls or faces may have profiles other than a straight line. A visually undesirable real estate use component may include a plurality of visually undesirable real estate uses. Also, an additional real estate use component may include a plurality of additional real estate uses. Alternatively, the additional real estate use components in FIGS. 1 and 2 might be subdivided horizontally, vertically, or both. The additional real estate use components in FIGS. 3-6 might be subdivided into more individual spaces than depicted. The development site zoning restrictions could be based on the current zoning restrictions or on the applicable future zoning restrictions after an anticipated rezoning request or variance. Alternatively, a common access area can be either an interior or exterior area. Also, the visually undesirable real estate use component may have a buffer area that may include but is not limited to a light well that is incorporated into the visually undesirable real estate use component. The light well may be placed along all or part of the common vertical wall. This buffer area could provide ventilation benefits, such as classifying a parking garage as an open parking garage, or act as a setback for fire code considerations.

Thus the scope should be determined by the appended claims and their legal equivalents, and not by the examples given.

1. A real estate development project located on a development site, where due to design constraints comprising:
a. a plurality of development site boundary distances;
b. a plurality of development site zoning restrictions, which may include a density restriction, a height restriction, a sky-plane restriction, or a setback restriction;
c. a visually undesirable real estate use component horizontal distance;
d. an additional real estate use component horizontal distance; and
e. a plurality of building code regulation requirements, which may include requirements for: (i) an exterior hallway; (ii) an interior hallway; (iii) a staircase; (iv) an elevator; (v) an escalator, and (vi) considerations regarding the Americans with Disabilities Act of 1990,
said development site still allows for a composite building structure, where said visually undesirable real estate use component is shielded, partially or wholly, from the public view from offsite of said development site by said additional real estate use component that is selected from the group consisting of:
f. a commercial use;
g. a residential use subdivided into a plurality of townhouse units; and
h. a residential use subdivided into a plurality of horizontal individual units, wherein said plurality of horizontal individual units are oriented so any access provided by a common access area does not provide access to 100% of said plurality of horizontal individual units on any floor, which may not have one consistent elevation.

2. The composite building structure of claim 1, wherein said visually undesirable real estate use component is selected from the group consisting of:
a. a boat dry stack storage facility;
b. a self storage facility;
c. a garbage facility;
d. a recycling facility;
e. a power generation facility; and
f. a data center facility.

3. The composite building structure of claim 1, wherein said additional real estate use component and said visually undesirable real estate use component share a common vertical wall.

4. The composite building structure of claim 1, wherein said additional real estate use component horizontal distance is less than 25 feet.

5. The composite building structure of claim 1, wherein said additional real estate use component horizontal distance is less than 20 feet.

6. The composite building structure of claim 1, wherein said additional real estate use component horizontal distance is less than 15 feet.

7. The composite building structure of claim 1, wherein said commercial use is selected from the group consisting of:
a. a restaurant use; and
b. an alcohol drinking establishment use.

8. The composite building structure of claim 7, wherein a common vertical wall, between said additional real estate use component and said visually undesirable real estate use component, is used for a bar or said bar's shelf area.

9. The composite building structure of claim 1, wherein said additional real estate use component is selected from the group consisting of:
a. a museum use; and
b. an art gallery use.

10. The composite building structure of claim 9, wherein a common vertical wall, between said additional real estate use component and said visually undesirable real estate use component, is used for hanging art or as the backdrop for sculptures.

11. The composite building structure of claim 1, wherein said composite building structure provides a first means for securing a local governmental rezoning approval.

12. The composite building structure of claim 1, wherein said composite building structure provides a second means for securing a governmental subsidy.

13. The composite building structure of claim 1, wherein a solar chimney provides a third means to enhance the natural stack ventilation of said visually undesirable real estate use component.

14. A method of designing a composite building structure, which is a real estate development project located on a development site, comprising:
a. determining the minimum volumetric configuration, based on a singular or a plurality of length, width, and height configurations, of a visually undesirable real estate use component;
b. determining, either based on the current zoning or on an anticipated rezoning request for said development site, any anticipated real estate uses for an additional real estate use component;
c. determining the interactions between: (i) said visually undesirable real estate use component; (ii) said additional real estate use component; (iii) a plurality of current development site zoning restrictions; (iv) a plurality of future said development site zoning restrictions amendment by an anticipated rezoning request; and (v) the local government's building code restrictions related to a plurality of possible composite building structures;
d. selecting a viable composite building structure;
e. comparing a selected said viable composite building structure with the designs of other alternative buildings; and
f. choosing said selected viable composite building structure if it provides more value than the designs of other alternative buildings,
wherein said visually undesirable real estate use component is shielded, partially or wholly, from the public view from offsite of said development site by said additional real estate use component that is selected from the group consisting of:
g. a commercial use;
h. a residential use subdivided into a plurality of townhouse units; and
i. a residential use subdivided into a plurality of horizontal individual units, wherein said plurality of horizontal individual units are oriented so any access provided by a common access area does not provide access to 100% of said plurality of horizontal individual units on any floor.

15. A method of claim 14, wherein said additional real estate use component is incidental to and not a driver of the demand for a visually undesirable real estate use component.

16. A method of claim 14, wherein said visually undesirable real estate use component is not a parking garage.

17. A method of claim 14, wherein said additional real estate use component is selected from the group consisting of:
a. a museum use; and
b. an art gallery use.

18. A method of claim 14, wherein said additional real estate use component is selected from the group consisting of:
a. a restaurant use; and
b. an alcohol drinking establishment use.

19. A method of claim 14, further comprising: (i) applying for; and (ii) securing, a local governmental rezoning approval that adds more value to said selected said composite building structure by receiving more favorable zoning restrictions for said development site.

20. A method of claim 14, further comprising: (i) applying for; and (ii) securing, a governmental subsidy that adds more value to said selected said composite building structure by helping finance said selected said composite building structure.
